(19) United States
(12) Patent Application Publication
(10) Pub. No.: US 2014/0019809 A1
(43) Pub. Date: Jan. 16, 2014

(54) REPRODUCTION SUPPORT APPARATUS, REPRODUCTION SUPPORT METHOD, AND COMPUTER PRODUCT

(71) Applicant: FUJITSU LIMITED, Kawasaki-shi (JP)

(72) Inventor: Yasuyuki Nagaoka, Kawasaki (JP)

(73) Assignee: FUJITSU LIMITED, Kawasaki-shi (JP)

(21) Appl. No.: 14/028,922

(22) Filed: Sep. 17, 2013

Related U.S. Application Data
(63) Continuation of application No. PCT/JP2011/056656, filed on Mar. 18, 2011.

(51) Int. Cl. G06F 11/36

(52) U.S. Cl. CPC G06F 11/3604
USPC 714/38.1

(57) ABSTRACT

A reproduction support apparatus supports reproduction of an OS is to be reproduced by a reproducing apparatus, and includes a processor configured to input a first identification data group that includes identification data identifying files of a file group constituting the OS to be reproduced; and a storage device storing a second identification data group that includes identification data identifying files of a file group constituting OSs of an OS group including the OS to be reproduced and the files of the file group constituting the OSs of the OS group. The processor is further configured to retrieve from the second identification data group, identification data matching the first identification data group; extract from the file group stored in the storage device, a file identified by the retrieved identification data; and transmit to the reproducing apparatus, information concerning files among the extracted files, for reproducing the OS to be reproduced.

### CROSS REFERENCE TO RELATED APPLICATIONS

This application is a continuation application of International Application PCT/JP2011/056656, filed on Mar. 18, 2011 and designating the U.S., the entire contents of which are incorporated herein by reference.

### FIELD

The embodiment discussed herein is related to a reproduction support apparatus, a reproduction support method, and a computer product that support reproduction of an operating system.

### BACKGROUND

A vendor receives a request for an investigation on an operating system (OS) used by a customer and investigates the OS used by the customer. For example, when a fault occurs in an apparatus of the customer, the vendor receives a request from the customer for an investigation on the cause of the fault. In this case, the “OS used by the customer” is an OS sold by the vendor, in the initial state or is an OS to which fault corrective data (hereinafter, “patch”) has been applied.

For the investigation of the fault, the vendor has to investigate the OS used by the customer, or has to reproduce the OS to be investigated and investigate the reproduced OS (hereinafter, referred to as the “OS to be reproduced) (see, e.g., Japanese Laid-Open Patent Publication Nos. 2004-26083, 2005-107803, and 2006-85408). The vendor investigates whether the OS is the cause of the fault, or which one of files of the OS is the cause of the fault.

According to a conventional technique of investigating a fault, the vendor visits the customer and investigates the fault by directly operating the OS used by the customer. According to another technique, the vendor copies into a computer of the vendor, the content of a storage apparatus retaining the OS used by the customer; reproduces in the computer of the vendor, the OS used by the customer; and investigates the fault.

According to another technique of investigating a fault, a log is used that indicates the types and the order of patches applied by a customer. For example, according to the log, the vendor installs the patches applied by the customer to an OS that is in the initial state in a computer of the vendor, and reproduces an OS identical to the OS used by the customer. The vendor investigates the fault on the reproduced OS (see, e.g., Japanese Laid-Open Patent Publication Nos. 2009-104393 and 2007-257046).

However, according to the techniques for the vendor to directly operate the OS of the customer and to copy the content of the storage apparatus of the customer, a problem concerning the security arises in that information that the customer desires to keep confidential may be become known to the vendor. Another problem arises in that the customer has to suspend operations when the vendor directly operates the OS of the customer or when the vendor copies the content of the storage apparatus of the customer.

According to the conventional techniques described in Japanese Laid-Open Patent Publication Nos. 2009-104393 and 2007-257046, a tremendous amount of time and a tremendous amount of labor are necessary for installing the patches into the computer of the vendor and therefore, much time is needed to reproduce the OS used by the customer. Therefore, another problem arises in that the investigation of the fault is delayed.

### SUMMARY

According to an aspect of an embodiment, a reproduction support apparatus supports reproduction of an operating system that is to be reproduced by a reproducing apparatus different from an apparatus operated by the OS to be reproduced. The reproduction support apparatus includes a processor configured to input a first identification data group that includes identification data uniquely identifying files of a file group constituting the OS to be reproduced; and a storage device that stores a second identification data group that includes identification data uniquely identifying files of a file group constituting OSs of a OS group including the OS to be reproduced and the files of the file group constituting the OSs of the OS group. The processor is further configured to retrieve from the second identification data group in the storage device and for each identification data of the first identification data group, identification data matching identification data of the first identification data group; extract from the file group stored in the storage device, a file identified by the retrieved identification data; and transmit to the reproducing apparatus, information concerning files that are among the extracted files and that are for reproducing the OS to be reproduced by the reproducing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of production of a reproduced OS for investigation, executed by a reproduction support apparatus;

FIG. 2 is a block diagram of a hardware configuration of a computer;

FIG. 3 is an explanatory diagram of a configuration of all-constituent-files information;

FIG. 4 is an explanatory diagram of the contents of all-files information;

FIG. 5 is a functional block diagram of a functional configuration of the reproduction support apparatus;

FIG. 6 is an explanatory diagram of a specific example of production of a database and the all-constituent-files information of the reproduction support apparatus;

FIG. 7 is an explanatory diagram of a configuration of tree structure;

FIG. 8 is an explanatory diagram of a configuration of the all-constituent-files information;

FIG. 9 is an explanatory diagram of a specific example of the production of the all-files information at a customer apparatus;

FIG. 10 is an explanatory diagram of a specific example of the all-files information produced by the customer apparatus;

FIGS. 11 and 12 are explanatory diagrams of a specific example of production of a reproduced OS for investigation at the reproduction support apparatus;

FIG. 13 is a flowchart of details of a database production process executed by the reproduction support apparatus;

FIG. 14 is a flowchart of details of a file information collection process executed by the customer apparatus; and

FIG. 15 is a flowchart of details of a production process for a reproduced OS for investigation executed by the reproduction support apparatus.

### DESCRIPTION OF EMBODIMENTS

Embodiments of a reproduction support apparatus, a reproduction support method, and a reproduction support program will be described in detail with reference to the accompanying drawings.

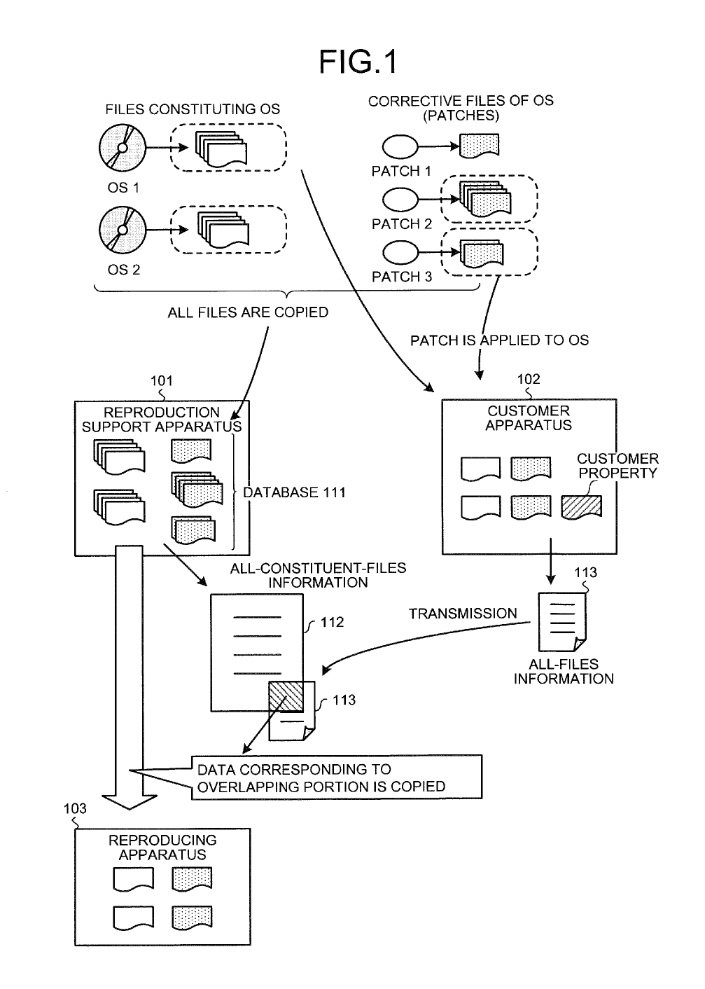

Production of a reproduced OS for investigation, executed by a reproduction support apparatus will be described with reference to FIG. 1. FIG. 1 is an explanatory diagram of the production of a reproduced OS for investigation, executed by the reproduction support apparatus. A vendor produces a reproduced OS for investigation. The reproduced OS is configured by same files as those of the OS to be reproduced. The “OS to be reproduced” is an OS reproduced by a reproducing apparatus of the vendor and is an OS used by another apparatus. The OS to be reproduced is, for example, an OS that has a fault and that is used by the apparatus of the customer. For example, when a fault occurs in the OS used by the apparatus of the customer, the vendor reproduces the OS with the fault therein in a reproducing apparatus and investigates the OS.

In this case, a computer used by the vendor to support the reproduction of the reproduced OS for investigation is referred to as “reproduction support apparatus 101”; a computer used by the customer is referred to as “customer apparatus 102”; and a computer executing the reproduction and the investigation by reproducing the OS to be reproduced is referred to as “reproducing apparatus 103”. The reproducing apparatus 103 is configured by hardware identical to the hardware of the customer apparatus 102.

The customer apparatus 102 uses an OS that is corrected by applying patches to one OS that is provided by the vendor and that is first installed thereto. For example, the customer apparatus 102 employs an OS that is obtained by applying a patch 3 to an OS 1. When a fault occurs in this corrected OS, the vendor reproduces in the reproducing apparatus 103, an OS that is the same as the OS in which the fault occurred and investigates the cause of the fault. The customer apparatus 102 also retains files that are produced by the customer and that are a property of the customer.

The vendor retains the files constituting all the OSs provided thereby in the past and the files of all the patches provided thereby in the past, in a storage apparatus of the reproduction support apparatus 101 as a database 111. The patches are each configured by files to substitute files constituting the OS or files to be added to the OS. The vendor produces a list of the files (hereinafter, referred to as “all-constituent-files information 112”) and retains the list in the storage apparatus of the reproduction support apparatus 101. Each of the files is correlated with identification data in the all-constituent-files information 112. The “identification data” is information with which the list including the correlations can uniquely be identified. For example, the identification data is any one of or a combination of at least any two of the file name after the installation, the path name after the installation, the file size, the file attribute, and a checksum calculated from the file.

It is assumed that a fault occurs in the customer apparatus 102. When the fault occurs, the customer apparatus 102 produces a list of the files therein (hereinafter, referred to as “all-files information 113”) and retains the list in the storage apparatus of the customer apparatus 102. The files in the apparatus of the customer apparatus 102 include files that are produced by the customer and that are a property of the customer, in addition to the files constituting the corrected OS.

Each of the files is correlated with the identification data thereof in the all-files information 113. The “identification data” is information with which the list including the correlations can uniquely be identified. For example, the identification data is any one of or a combination of at least any two of the file name after the installation, the path name after the installation, the file size, the file attribute, and a checksum calculated from the file. The all-files information 113 includes only the identification data and therefore, includes no contents of any file. The customer apparatus 102 transmits the produced all-files information 113 to the reproduction support apparatus 101. The customer apparatus 102 may be adapted to record the all-files information 113 into a recording medium and the reproduction support apparatus 101 may be adapted to read the recorded all-files information 113.

The reproduction support apparatus 101 receives the all-files information 113 from the customer apparatus 102 and retrieves the identification data from the received all-files information 113 and that from the received all-constituent-files information 112, that match with each other. Thereby, it is determined that, among the files retained in the database 111 of the reproduction support apparatus 101, the file corresponding to the retrieved identification data is the file that constitutes the OS of the customer apparatus 102.

The reproduction support apparatus 101 copies into the reproducing apparatus 103, the files that are determined to be the files constituting the OS of the customer apparatus 102. For example, the reproduction support apparatus 101 copies (installs) the files that are determined to be the files constituting the OS of the customer apparatus 102, via the network into the reproducing apparatus 103 into which only the OS in the initial state is installed.

In this manner, the reproduction support apparatus 101 copies into the reproducing apparatus 103, the files necessary for reproducing an OS that is the same as that of the customer apparatus 102 and therefore, the reproducing apparatus 103 may easily construct the reproduced OS for investigation to reproduce and investigate the fault. The customer apparatus 102 merely has to transmit (but not limited to transmitting) the all-files information 113 that includes no content itself of any file and therefore, even when the customer apparatus 102 retains the property of the customer, the property of the customer to be concealed is not compromised. For the reproducing apparatus 103, the reproduction support apparatus 101 merely has to copy the constituent files of the OS and does not need to apply any patch. Therefore, the labor and the time necessary for the application of the patches can be excluded.

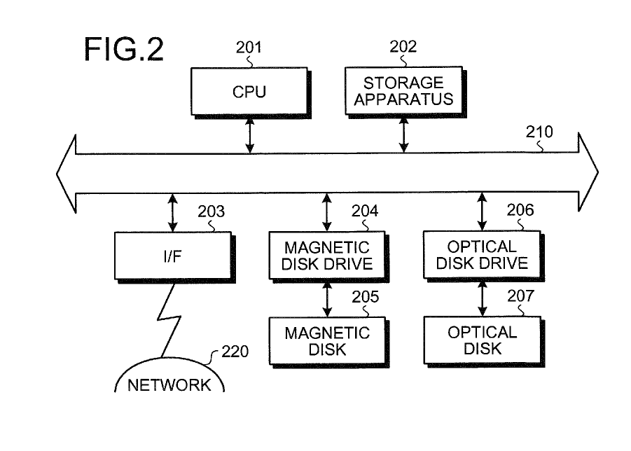

A hardware configuration of a computer will be described with reference to FIG. 2. Here, a computer is, for example, the reproduction support apparatus 101, the customer apparatus 102, and the reproducing apparatus 103.

FIG. 2 is a block diagram of a hardware configuration of a computer. As depicted in FIG. 2, the computer includes a central processing unit (CPU) 201, a storage apparatus 202, an interface (I/F) 203, a magnetic disk drive 204, a magnetic disk 205, an optical disk drive 206, and an optical disk 207, respectively connected by a bus 210.

The CPU 201 governs overall control of the computer. The storage apparatus 202 stores a reproduction support program. As the reproduction support program, for example, a database production process, an information extraction process, a checksum calculation process, and a producing process of reproducing an OS, respectively described hereinafter, are stored. Further, the storage apparatus 202 stores the all-constituent-files information 112 and the all-files information 113. The storage apparatus 202 stores the database 111. Non-volatile memory, flash memory, a hard disk drive, and the like may be adopted as the storage apparatus 202.

The I/F 203 is connected to a network 222 such as a local area network (LAN), a wide area network (WAN), and the Internet, and is connected to other apparatuses through the network 220. The I/F 203 administers an internal interface with the network 220 and controls the input and output of data with respect to external apparatuses. A modem and LAN adapter may be adopted as the I/F 203.

The magnetic disk drive 204, under the control of the CPU 201, controls the reading and writing of data with respect to the magnetic disk 205. The magnetic disk 205 stores the data written thereto under the control of the magnetic disk drive 204.

The optical disk drive 206, under the control of the CPU 201, controls the reading and writing of data with respect to the optical disk 207. The optical disk 207 stores the data written thereto under the control of the optical disk drive 206, the data being read out by a computer.

Here, although the database 111 has been described to be stored in the storage apparatus 202, the database 111 may stored in an external server and data may be input and output via the I/F 203, from the computer to the external server.

The configuration of the all-constituent-files information 112 depicted in FIG. 1 will be described.

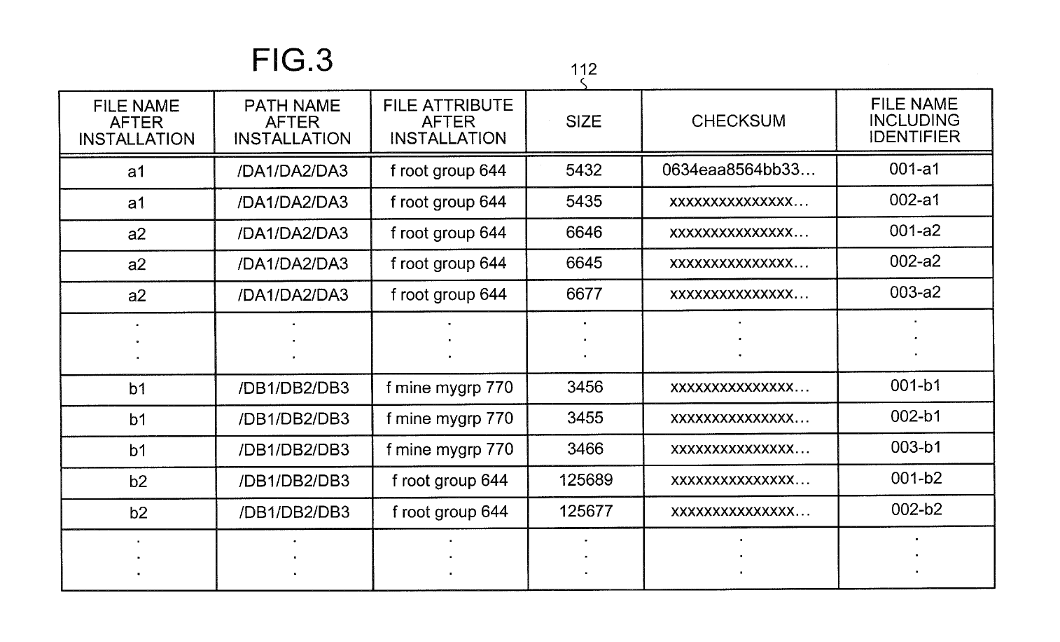

FIG. 3 is an explanatory diagram of the configuration of the all-constituent-files information 112. As depicted in FIG. 3, the all-constituent-files information 112 includes an after-installation path name item, an after-installation file attribute item, a size item, a checksum item, and an identifier-included file name item, respectively correlated with each of the identifier-included file name items; and constituting a record for each identifier-included file name.

An after-installation file name item stores the file name of a constituent file of the OS or the file name of the patch. Files having the same name are present in the after-installation file name item. However, for example, although these files have the same name, the patches included have differing version numbers and therefore, these files include content different from that of each other, while having the same name.

The after-installation path name item stores a character string that represents the location of the constituent file of the OS or the file of the patch in a storage apparatus 202 of the reproduction support apparatus 101.

The after-installation file attribute item stores the file attribute of the constituent file of the OS or the file of the patch. The “file attribute” refers to any one of the type of file, the system owner's name, the group name, and the editorial control.

The size item stores the size of the file. The unit of the size is, for example, a byte.

The checksum item stores the checksum. The checksum will not be described in detail because the checksum is a known technique. However, the checksum refers to a hash value of a file and is a value used for guaranteeing the identification of the file. For example, the message digest algorithm 5 (MD 5) can be employed as an approach to the checksum.

The identifier-included file name item stores the file name used in the database 111. The identifier is attached to identify each of files that have same names and whose contents differ from each other. In this example, though a prefix is used as an identifier, a suffix may be used.

A configuration of the all-files information 113 depicted in FIG. 1 will be described.

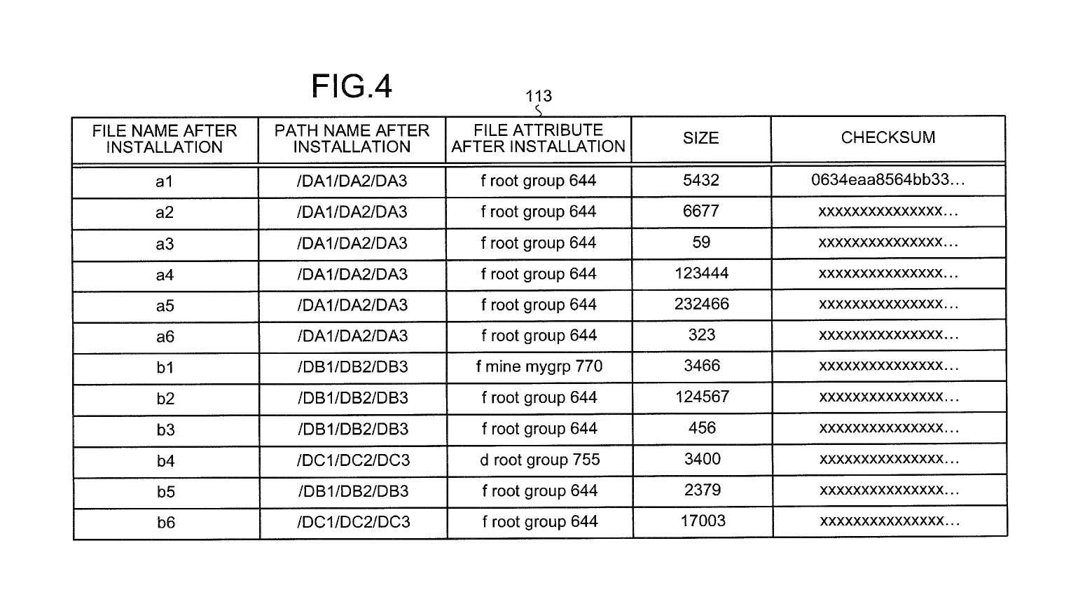

FIG. 4 is an explanatory diagram of the contents of the all-files information 113. As depicted in FIG. 4, the all-files information 113 includes an after-installation path name item, an after-installation file attribute item, a size item, and a checksum item, respectively correlated with each of after-installation file name items; and constituting a record for each of the after-installation file names.

The after-installation file name item stores the file name of a constituent file of the OS or the patch, retained in the storage apparatus 202 of the customer apparatus 102. Files having the same names are present in the after-installation file name item. However, for example, although these files are files have the same name, the patches included have differing version numbers and therefore, these files include content different from that of each other, while having the same name.

The after-installation path name item stores a character string that represents the location of the constituent file of the OS or the file of the patch in the storage apparatus 202 of the customer apparatus 102.

The after-installation file attribute item stores the file attribute of the constituent file of the OS or the file of the patch that is installed into the customer apparatus 102. The size item and the checksum item respectively store the contents same as those of the size item and the checksum item in FIG. 3.

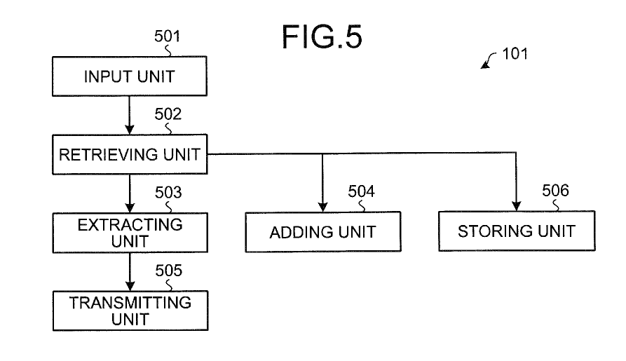

A functional configuration of the reproduction support apparatus 101 will be described with reference to FIG. 5.

FIG. 5 is a functional block diagram of a functional configuration of the reproduction support apparatus. As depicted in FIG. 5, the reproduction support apparatus 101 includes an input unit 501, a retrieving unit 502, an extracting unit 503, an adding unit 504, a transmitting unit 505, and a storing unit 506.

The input unit 501 has a function of inputting a first identification data group that includes identification data that respectively uniquely identify the file of a file group constituting the OS to be reproduced. The “OS to be reproduced” is, for example, the OS of the customer apparatus 102. The “first identification data group” is the all-files information 113. The “identification data that respectively uniquely identify the file of the file group constituting the OS to be reproduced” are identification data correlated with the files in the all-files information 113.

For example, the input unit 501 receives the all-files information 113 transmitted from the customer apparatus 102, or reads the all-files information 113 from the recording medium using the magnetic disk drive 204 or the optical disk drive 206. Thereby, the input unit 501 can acquire the all-files information 113.

The input unit 501 has a function of inputting an arbitrary file. The “arbitrary file” is, for example, a constituent file of the OS or a file of a patch to be a constituent file of the OS by application of the patch. For example, the input unit 501 reads the constituent file of the OS or the file of the patch from the recording medium using the magnetic disk drive 204 or the optical disk drive 206.

Thereby, the input unit 501 acquires the constituent file of the OS or the file of the patch and adds to the all-constituent-files information 112, the identification data that uniquely identify the constituent files of the OS or the files of the patch. Thus, the input unit 501 acquires the constituent file of the OS or the file of the patch and causes the storing unit 506 described hereinafter to store the constituent file of the OS or the file of the patch in the database 111.

A function of the input unit 501 is implemented by, for example, causing the CPU 201 to execute the reproduction support program stored in the storage apparatus 202 depicted in FIG. 2 and using the I/F 203, the magnetic disk drive 204, or the optical disk drive 206.

The retrieving unit 502 has a function of retrieving for each identification data of the first identification data group, identification data that matches identification data of the first identification data group. The retrieving unit 502 retrieves the matching data from a second identification data group that includes identification data uniquely identifying files of a file group constituting each OS of the OS group including the OS to be reproduced.

The “file group constituting each OS of the OS group including the OS to be reproduced” includes the files constituting all the OSs provided by the vendor and the files included in all the patches. The “second identification data group” is the all-constituent-files information 112. The “identification data uniquely identifying files of the file group constituting each OS of the OS group” are respectively any one of or a combination of at least any two of the after-installation file name, the after-installation path name, the file size, the file attribute, and a checksum calculated from the file in the all-constituent-files information 112. The “identification data that matches the identification data of the first identification data group” is the identification data of the all-files information 113 and that of the all-constituent-files information 112 that have after-installation file names, after-installation path names, file attributes, file sizes, and checksums that respectively match each other.

For example, the retrieving unit 502 retrieves the identification data of the all-files information 113 and that of the all-constituent-files information 112 that have the after-installation file names, the after-installation path names, the file attributes, the file sizes, and the checksums that respectively match each other. The retrieving unit 502 may retrieve the identification data whose any one of or a combination of at least any two among the after-installation file name, the after-installation path name, the file size, the file attribute, and the checksum matches those designated in advance by the vendor. Thus, the retrieving unit 502 checks by the retrieval whether a constituent file that is the same as the constituent file of the OS of the customer apparatus 102 is retained in the storage apparatus 202 of the reproduction support apparatus 101.

The retrieving unit 502 has a function of retrieving the identification data that uniquely identifies the file input by the input unit 501, from the second identification data group. For example, the retrieving unit 502 retrieves the record of the all-constituent-file information 112 whose after-installation file name, after-installation path name, file attribute, the file size, and the checksum respectively match those of the input file. The retrieving unit 502 may retrieve the identification data whose any one of or a combination of at least any two among the after-installation file name, the after-installation path name, the file size, the file attribute, and the checksum matches those designated in advance by the vendor.

Thus, it may be checked by the retrieval whether the constituent file of the OS or the file of the patch input by the input unit 501 is retained in the database 111 of the reproduction support apparatus 101. Thereby, the retrieving unit 502 is able to determine whether the input file is retained in the database 111. If the retrieving unit 502 determines that the input file is not retained in the database 111, the retrieving unit 502 causes the storing unit 506 to store the file to the database 111.

A function of the retrieving unit 502 is implemented by, for example, causing the CPU 201 to execute the reproduction support program stored in the storage apparatus 202 depicted in FIG. 2.

The extracting unit 503 has a function of extracting the file identified by the identification data retrieved by the retrieving unit 502, from the file group stored in a storage device. The “storage device” is the storage apparatus 202 and includes a database that stores the second identification data group including the identification data that uniquely identifies the files of the file groups constituting the OSs of the OS group including the OS to be reproduced together with the files of the file group constituting the OSs of the OS group. The “database” is the database 111 in the storage apparatus 202 storing the file group that includes the files identified by the identification data of the second identification data group.

For example, the extracting unit 503 extracts from the database 111, the file of the file name including the identifier in the record retrieved by the retrieving unit 502. Thereby, the extracting unit 503 may extract from the database 111, the files constituting the OS of the customer apparatus 102.

In this case, the files extracted by the extracting unit 503 may be stored in a recording medium or may be input into the reproducing apparatus 103 through the recording medium. When the reproduction support apparatus 101 has a function as the reproducing apparatus 103, the reproduction support apparatus 101 may also reproduce the OS to be reproduced in the reproduction support apparatus 101 using the file extracted by the extracting unit 503. For example, the reproduction support apparatus 101 is configured to be able to employ dual boot of the OS and an area sectioned by a partition may be used as the work area for the reproducing apparatus 103. The reproduction support apparatus 101 may newly install into the area sectioned by the partition from the extracted files, an OS that is the same as that of the customer apparatus 102.

A function of the extracting unit 503 is implemented by, for example, causing the CPU 201 to execute the reproduction support program stored in the storage apparatus 202 depicted in FIG. 2.

The adding unit 504 has a function of adding the identification data that uniquely identifies an arbitrary file, to the second identification data group, when the retrieving unit 502 retrieves no identification data. The “arbitrary file” is, for example, a constituent file of the OS or a file of the patch to be a constituent file of the OS by the application of the patch. For example, if the identification data uniquely identifying the file input by the input unit 501 can not be retrieved from the all-constituent-files information 112 by the retrieving unit 502, the adding unit 504 adds the identification data uniquely identifying the file input by the input unit 501 to the all-constituent-files information 112 retained in the storage apparatus 202.

Thereby, for example, the adding unit 504 adds a record to the all-constituent-files information 112 for the file input by the input unit 501 from the recording medium prepared by the vendor to produce the database 111. For example, the adding unit 504 can add a record to the all-constituent-files information 112 for the file of a new patch when the new patch produced by the vendor is input.

A function of the adding unit 504 is implemented by, for example, causing the CPU 201 to execute the reproduction support program stored in the storage apparatus 202 depicted in FIG. 2.

The transmitting unit 505 has a function of transmitting information concerning the files necessary for reproducing the reproduced OS, from the file group including the files extracted by the extracting unit 503. The “files necessary for reproducing the reproduced OS” are, for example, the files remaining after excluding the files of the file group constituting the OS at its installation from the file group including the files extracted by the extracting unit 503.

For example, the transmitting unit 505 transmits the files remaining after excluding the files of the file group constituting the OS at its installation from the file group including the files extracted by the extracting unit 503, to the computer having therein the file group constituting the OS at installation, of the OS to be reproduced.

The “OS at installation, of the OS to be reproduced” is the OS in the initial state before the application of any patch to the OS of the customer apparatus 102, and is, for example, the OS at the time of the shipment of the customer apparatus 102. The “computer having therein the file group constituting the OS at installation” is the reproducing apparatus 103.

For example, the remaining files can be acquired by storing the constituent files of the OS at the time of the shipment of the customer apparatus 102, to the storage apparatus 202; and comparing the files extracted by the extracting unit 503 with the stored constituent files. The transmitting unit 505 merely has to transmit at least the remaining files or may transmit all the extracted files. In this case, the files necessary for reproducing the reproduced OS are selected by the reproducing apparatus 103.

The reproducing apparatus 103 in this case operates based on, for example, the OS in initial state and operates based on an OS that is the same as that of the customer apparatus 102 by installing thereto the received files. The reproducing apparatus 103 is configured to, for example, be able to execute the dual boot of the OS, operates based on the OS of the reproducing apparatus 103, and may newly be installed with an OS that is the same as that of the customer apparatus 102 in the area sectioned by the partition, from the received files.

For example, the transmitting unit 505 transmits files to substitute the files constituting the OS of the reproducing apparatus 103 and files to be added to the OS thereof, through the network 220. Thereby, the transmitting unit 505 can cause the reproducing apparatus 103 to configure an OS same as that of the customer apparatus 102.

A function of the transmitting unit 505 is implemented by, for example, causing the CPU 201 to execute the reproduction support program stored in the storage apparatus 202 depicted in FIG. 2 and using the I/F 203.

The storing unit 506 has a function of correlating and storing an arbitrary file and the identification data uniquely identifying the arbitrary file, to the storage device that stores the file group constituting the OSs of the OS group. The “storage device” is the storage apparatus 202 and, for example, is the database 111 storing the file group that constitutes the OSs of the OS group. The “arbitrary file” is, for example, a constituent file of the OS or a file of the patch to be the constituent file of the OS by the application of the patch. For example, the storing unit 506 retains the files input thereto by the input unit 501, in the database 111 correlating the files with the all-constituent-files information 112.

Thereby, for example, the storing unit 506 can store in the database 111, the files input thereto by the input unit 501, from the recording medium prepared by the vendor to produce the database 111. For example, when a new patch produced by the vendor is input, the storing unit 506 can further store the file of the patch to the database correlating the file with the identification data.

A function of the storing unit 506 is implemented by, for example, causing the CPU 201 to execute the reproduction support program stored in the storage apparatus 202 depicted in FIG. 2 and using the storage apparatus 202.

The production of the database 111 and the all-constituent-files information 112 of the reproduction support apparatus 101 will be described.

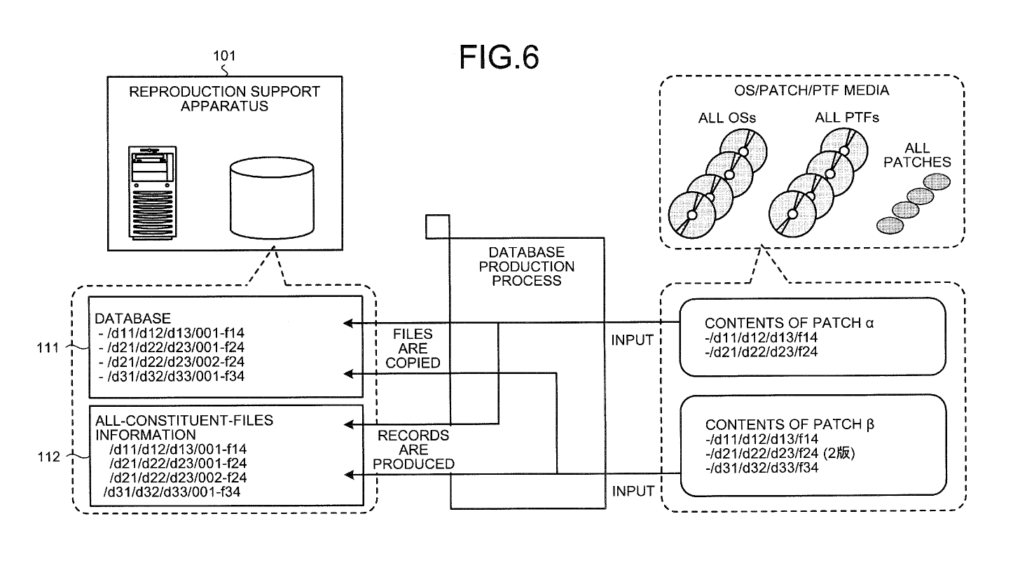

FIG. 6 is an explanatory diagram of a specific example of the production of the database 111 and the all-constituent-files information 112 of the reproduction support apparatus. Before a request for investigation by reproduction arrives from the customer, the vendor disassembles all the OSs, all the patches, and all the program temporary fixes (PTFs) provided by the vendor in the past, into individual files and produces the all-constituent-files information 112. Concurrently, the vendor disassembles all the OSs, all the patches, and all the PTFs provided by the vendor in the past, into individual files and accumulates these files in the database 111. The “PTF” is an aggregate of the patches.

For example, the vendor inputs the individual files of the OSs, the PTFs, and the patches from the recording medium having all the OSs, all the PTFs, and all the patches provided by the vendor in the past recorded thereon, into the reproduction support apparatus 101. The reproduction support apparatus 101 adds records for the input files to the all-constituent-files information 112. Concurrently, the reproduction support apparatus 101 retains the input files in the storage apparatus 202 as the database 111 having a tree structure.

An example will be described where the database 111 and the all-constituent-files information 112 are produced from the files of patches α and β. The storage apparatus 202 of the reproduction support apparatus 101 stores a database production process. For example, the content “-/d11/d12/d13/f14” of the patch α is expresses that the file f14 is a file copied in a directory d13 under a directory d12 under a directory d11 under a root when the file f14 is installed.

The reproduction support apparatus 101 executes the database production process and produces the database 111 and the all-constituent-files information 112. The reproduction support apparatus 101 produces the database 111. For example, the reproduction support apparatus 101 produces a directory of the path used for the installation, changes the file name of the patch to a file name including an identifier, and copies the file into the produced directory. A three-digit prefix is given thereto as the identifier.

For example, for the file f14 of the patch α: the directories d11, d12, and d13 are produced in the database 111 according to the structure of the path “-/d11/d12/d13/” used when the file is installed; the file name “f14” is converted into the file name including the identifier “001-f14”; and the file f14 is retained in the produced directory d13. Similarly, for the file f24 of the patch α: directories d21, d22, and d23 are produced in the database 111 according to the structure of the path “-/d21/d22/d23/” used when the file is installed; the file name “f24” is converted into the file name including the identifier “001-f24”; and the file 001-f24 is stored in the produced directory d23.

If a file having the same name and the same content as those of the file f14 of the patch α is input such as a file f14 of the patch β, the reproduction support apparatus 101 does not copy the file f14 of the patch β. On the other hand, if a file having the same name as that and content different from that of the file f24 of the patch α is input such as a file f24 of the patch β, the file name “f24” is converted into a file name including an identifier “002-f24” and the file 002-f24 is stored in the produced directory d23.

Concurrently with the production of the database 111, the reproduction support apparatus 101 adds a record to the all-constituent-files information 112. For example, the reproduction support apparatus 101 adds to the all-constituent-files information 112 as a record the file name used when the file of each patch is installed, the path name used for the installation, the file attribute, the file size, the checksum of the file, and the file name including the identifier. However, in this case, for simplification, description will be made assuming that only the path name and the file name including the identifier used for the installation are described in the all-constituent-files information 112.

When the record is produced, for example, for the file f14 of the patch α, the path name “-/d11/d12/d13/” and the file name including the identifier “001-f14” attached with a prefix “001” used for the installation are added as a record to the all-constituent-files information 112. Similarly, for the file f24 of the patch α, the path name “-/d21/d22/d23/” and the file name including the identifier “001-f24” attached with a prefix “001” used for the installation are added as a record to the all-constituent-files information 112.

When a file having the same name and the same content as those of the file f14 of the patch α is input such as the file f14 of the patch β, no record is added. On the other hand, when a file having the same name as that and content different from that of the file f24 of the patch α is input such as the file f24 of the patch β, the file name including the identifier “002-f24” attached with a different prefix “002” is produced and is added as another record. In this manner, the reproduction support apparatus 101 produces the all-constituent-file information 112 and the database 111.

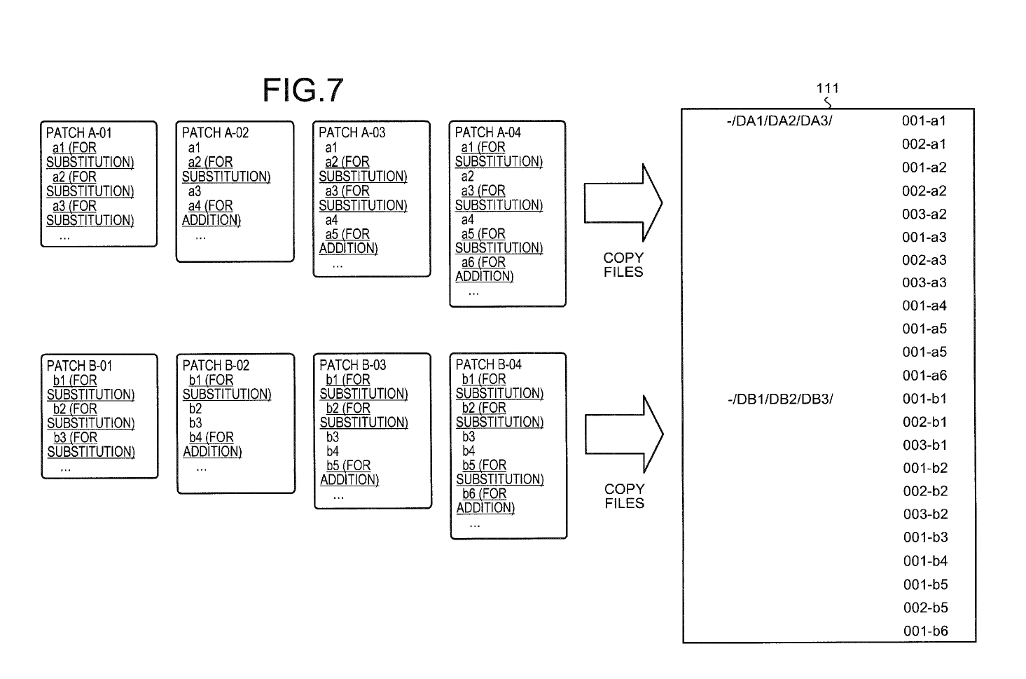

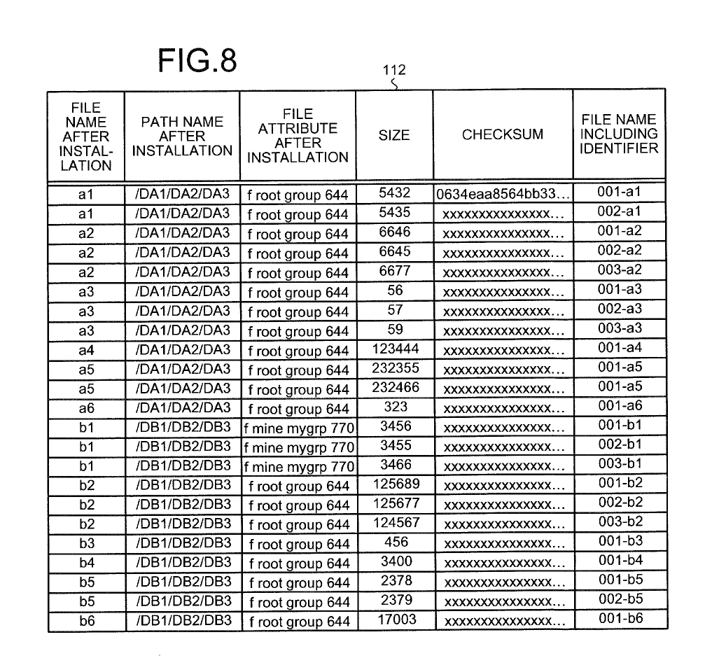

The configurations of the tree structure formed by disposing the contents of actual patches and the patches on the database 111, and the all-constituent-files information 112 will be described. FIG. 7 is an explanatory diagram of the configuration of the tree structure. FIG. 8 is an explanatory diagram of the configuration of the all-constituent-files information 112.

For example, the “contents of the actual patches” are patches A-01 to A-04 and patches B-01 to B-04. To the patches is attached with a unique ID for each of the components configuring the OS (such as, for example, a supervisor, drivers controlling various I/Os, a library, a command, and an information file). In this case, it is assumed that the ID is an ID formed by attaching a version number of the patch to an alphabetic character and that the files of the patches A-01 to A-04 are retained at position of “-/DA1/DA2/DA3/” and the files of the patches B-01 to B-04 are the files retained at the position of “-/DB1/DB2/DB3/”.

The patch includes plural files to substitute the files already present in the OS (that are each labeled as “FOR SUBSTITUTION” in FIG. 7) or plural files to be newly added to the OS (that are each labeled as “FOR ADDITION” in FIG. 7). As to a patch, when a file of the patch is corrected, the files included in the previous version must be inherited and the corrected file is added. Therefore, even a file without any correction is inherited and is included in the patch.

The “file having the same name and the same content” is an inherited file and is, for example, a file al of the patch A-01 for a file al of the patch A-02. The “file having the same name and differing content” is a file to substitute a file already present in the OS and is, for example, a file al of the patch A-03 for a file al of the patch A-04.

Therefore, when the files of the patches A-01 to A-04 and B-01 to B-04 depicted in FIG. 7 are input, the database 111 having the tree structure depicted in FIG. 7 is produced and the all-constituent-files information 112 depicted in FIG. 8 is also produced.

A “prefix”: is attached to separately record each of the files that have the same name and differing contents from each other and to separately retain each thereof from each other; therefore, the prefix does not need to be a digit corresponding to the version number of the patch; may be an arbitrary character string not limited to a digit; and does not have to be a prefix but may be a suffix. Otherwise, a directory for distinction thereof may be produced.

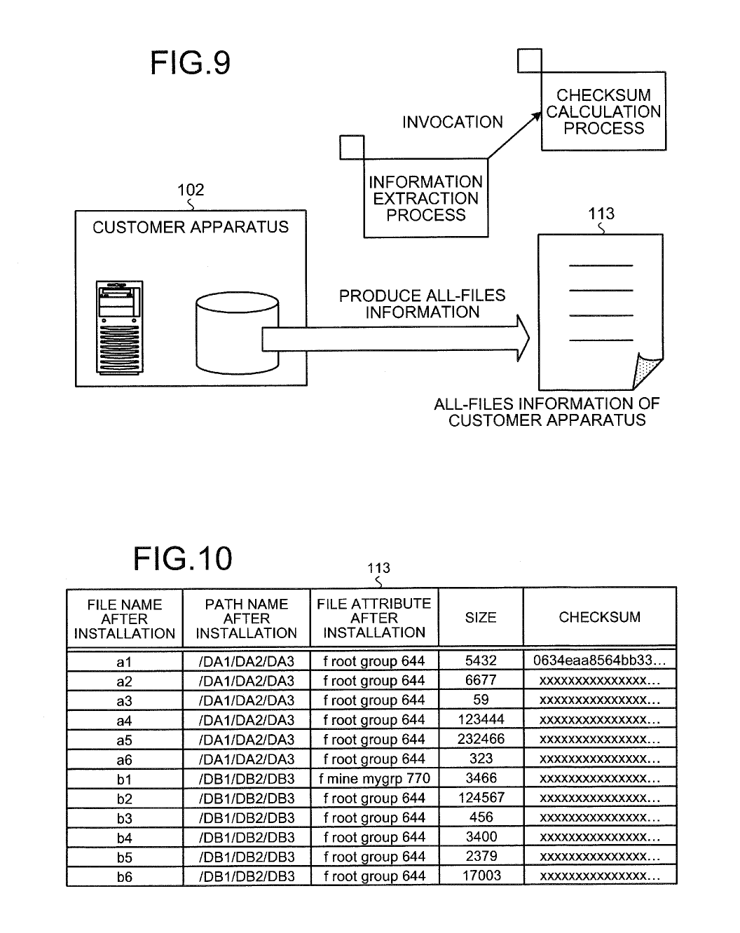

The production of the all-files information 113 at the customer apparatus 102 will be described with reference to FIGS. 9 and 10.

FIG. 9 is an explanatory diagram of a specific example of the production of the all-files information 113 at the customer apparatus 102. FIG. 10 is an explanatory diagram of a specific example of the all-files information 113 produced by the customer apparatus 102. When a fault occurs in the OS of the customer apparatus 102, the customer apparatus 102 produces the all-files information 113. The storage apparatus 202 of the customer apparatus 102 stores an execution file of programs for the vendor to execute an information extraction process and a checksum calculation process.

The customer apparatus 102 executes the information extraction process stored in the storage apparatus 202. The information extraction process is a process of extracting the after-installation file name, the after-installation path name, the file attribute, and the file size from each of all the files retained in the storage apparatus 202 of the customer apparatus 102. The information extraction process is a process of invoking the checksum calculation process and the invoked checksum calculation process is a process of calculating the checksum of the file.

Based on the extracted information and the calculated values, the customer apparatus 102 produces the all-files information 113 using the after-installation path name, the after-installation file attribute, the file size, and the checksum as a record for each after-installation file name. In this manner, the customer apparatus 102 can produce the all-files information 113 as depicted in FIG. 10.

The produced all-files information 113 is input into the reproduction support apparatus 101. The inputting into the reproduction support apparatus 101 may be executed by transmission by the customer apparatus 102 to the reproduction support apparatus 101 through the network 220 or may be executed by causing the reproduction support apparatus 101 to read the recording medium having the all-files information 113 recorded thereon.

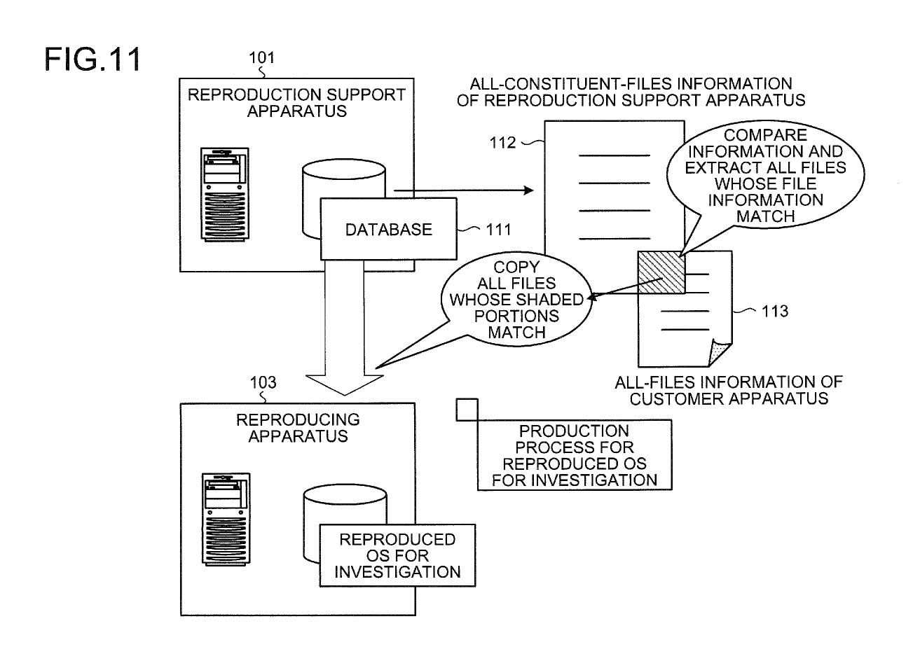

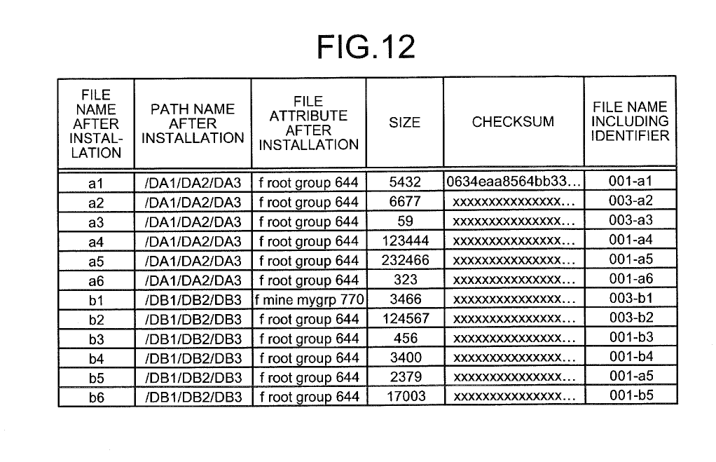

The production of the reproduced OS for investigation in the reproduction support apparatus 101 will be described with reference to FIGS. 11 and 12.

FIGS. 11 and 12 are explanatory diagrams of a specific example of the production of the reproduced OS for investigation at the reproduction support apparatus 101. Based on the all-files information 113 and the all-constituent-files information 112, the reproduction support apparatus 101 extracts the same files as the files configuring the OS of the customer apparatus 102 from the database 111 and produces the reproduced OS for investigation.

The storage apparatus 202 of the reproduction support apparatus 101 stores a reproduced OS for investigation production process; and retains the all-files information 113, the all-constituent-files information 112, and the database 111. The reproduction support apparatus 101 and the reproducing apparatus 103 are connected to each other through the network 220.

The reproduction support apparatus 101 executes the reproduced OS for investigation production process stored in the storage apparatus 202. The reproduced OS for investigation production process is a process of comparing the all-files information 113 and the all-constituent-files information 112, and extracting from the all-constituent-files information 112, records whose file information matches the file information of a record in the all-files information 113. For example, according to the process, from the all-constituent-files information 112, records are extracted that have the after-installation file names, the after-installation path names, the file attributes, the file sizes, and the checksums respectively matching those of a record of the all-files information 113. A matching file list is produced from the extracted records.

The files identified from the records in the matching file list are extracted from the database 111. For example, in the database 111, a file is extracted that has the file name that includes the identifier recorded at a position having the after-installation path name of the record of the matching file list. The reproduction support apparatus 101 copies the extracted file into the position of the after-installation path in the storage apparatus 202 of the reproducing apparatus 103. However, for this copying, the reproduction support apparatus 101 converts the file name of the extracted file into the after-installation file name and executes the copying.

For example, the matching file list is a list as depicted in FIG. 12. As described, the reproduction support apparatus 101 is able extract the record concerning the file that is the same as the file constituting the OS of the customer apparatus 102 from the database 111 using the matching file list.

The reproducing apparatus 103 operates based on, for example, an OS that is the same as the OS in the initial state of the customer apparatus 102 and may be adapted to operate based on an OS that is the same as that of the customer apparatus 102 by installing thereto the files copied from the reproduction support apparatus 101. The reproducing apparatus 103 is configured to, for example, be able to execute the dual boot of the OS, operates based on the OS of the reproducing apparatus 103, and may newly be installed with an OS same as that of the customer apparatus 102 in the area sectioned by the partition, from the files copied from the reproduction support apparatus 101.

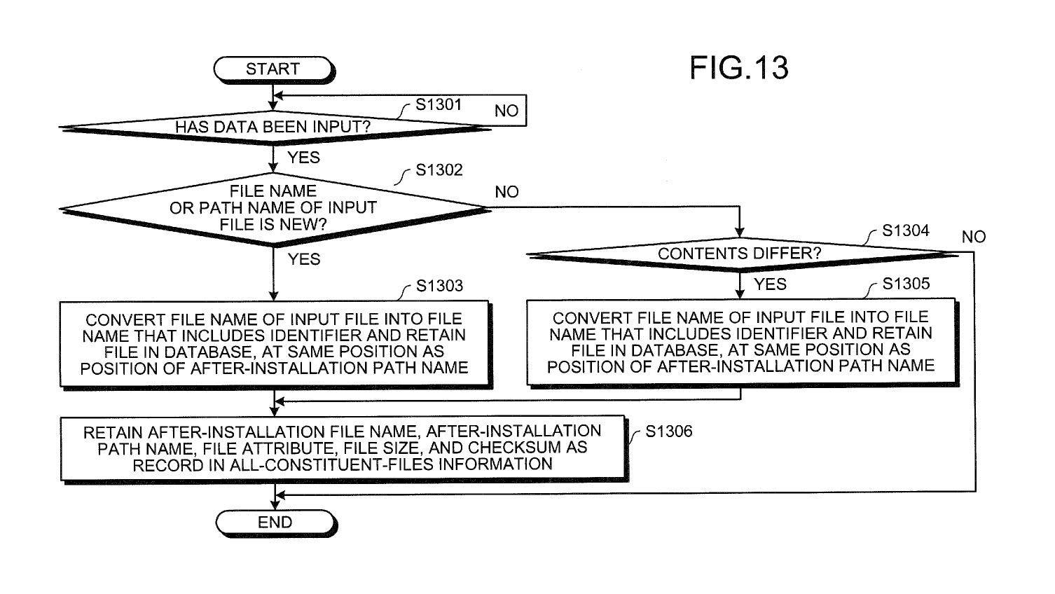

Details of a database production process will be described that is executed by the reproduction support apparatus 101. The database production process is the content of the process of the database production process. FIG. 13 is a flowchart of details of the database production process executed by the reproduction support apparatus. The CPU 201 of the reproduction support apparatus 101 determines whether data of the files constituting the OS, the files of the PTF, and the files of the patches have been input (step S1301). If the CPU 201 determines that the data has not been input (step S1301: NO), the CPU 201 returns to the operation at step S1301.

If the CPU 201 determines that the data has been input (step S1301: YES), the CPU 201 of the reproduction support apparatus 101 determines whether the after-installation file name or the after-installation path name of the input file is a new file name or a new path name that is not yet retained in the all-constituent-files information 112 (step S1302).

If the CPU 201 determines that the file name or the path name is a new file name or a new path name (step S1302: YES), the CPU 201 progresses to the operation at step S1303. At step S1303, the CPU 201 of the reproduction support apparatus 101 converts the file name of the input file into the file name that includes the identifier and retains the input file in the database 111, at the position that is the same as the position of the after-installation path name of the input file (step S1303), and the CPU 201 progresses to the operation at step S1306.

If the CPU 201 determines that the file name or the path name is not a new file name or a new path name, that is, when a file having the same name is present at the position of the same path name in the database 111 (step S1302: NO), the CPU 201 of the reproduction support apparatus 101 determines whether the content of the input file and the content of the file already retained in the database 111 are different from each other (step S1304). If the CPU 201 determines that the contents do not differ from each other, that is, when the contents are the same as each other (step S1304: NO), the CPU 201 causes the database production process to come to an end.

If the CPU 201 determines that the contents differ from each other (step S1304: YES), the CPU 201 of the reproduction support apparatus 101 converts the file name of the input file into the file name that includes the identifier that is different from that of the file already retained in the database 111. The CPU 201 of the reproduction support apparatus 101 retains in the database 111, the file having the converted file name, at a position that is the same as the position of the after-installation path name of the input file (step S1305) and progresses to the operation at step S1306.

At step S1306, the CPU 201 of the reproduction support apparatus 101 retains the after-installation file name, the after-installation path name, the file attribute, the file size, and the checksum of the input file as a record in the all-constituent-files information 112 (step S1306) and causes the database production process to come to an end. Thus, the all-constituent-files information 112 and the database 111 are produced for all the files input by the vendor into the reproduction support apparatus 101.

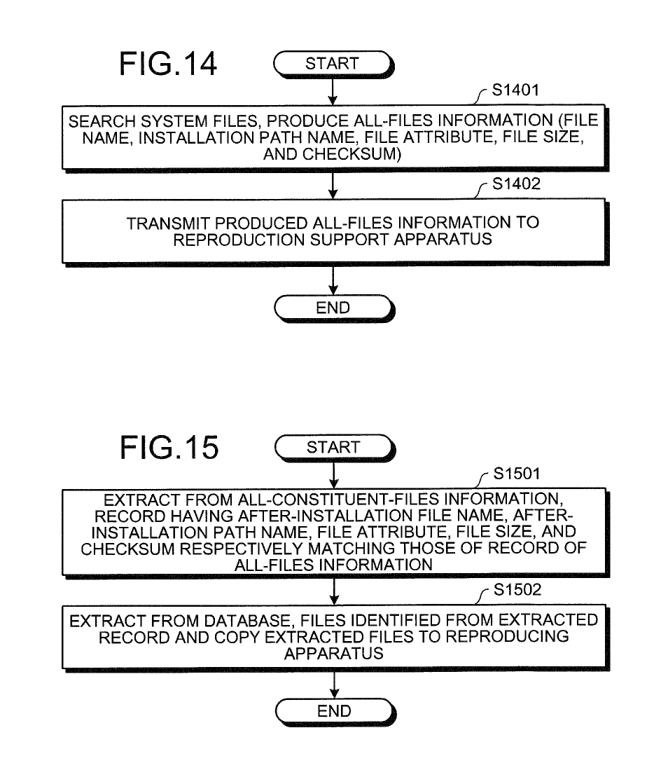

A file information collection process executed by the customer apparatus 102 will be described. The file information collection process is the content of the processes of the information extraction process and the checksum calculation process. FIG. 14 is a flowchart of details of the file information collection process executed by the customer apparatus 102.

The CPU 201 of the customer apparatus 102 checks all the files in the apparatus; extracts the after-installation file name, the after-installation path name, the file attribute, and the file size of each of all the files; and concurrently calculates the checksums of the files. The CPU 201 produces the all-files information 113 as a record including the after-installation file name, the after-installation path name, the file attribute, the file size, and the checksum of each of the files (step S1401). The CPU 201 transmits the produced all-files information 113 to the reproduction support apparatus 101 through the network 220 (step S1402) and causes the file information collection process to come to an end.

A production process of a reproduced OS for an investigation executed by the reproduction support apparatus 101 will be described. The production process for a reproduced OS for investigation is the content of the process of the reproduced OS for investigation production process. FIG. 15 is a flowchart of details of the production process for a reproduced OS for investigation executed by the reproduction support apparatus 101.

The CPU 201 of the reproduction support apparatus 101 extracts from the all-constituent-files information 112, a record having an after-installation file name, an after-installation path name, a file attribute, a file size, and a checksum respectively matching those of a record of the all-files information 113 (step S1501).

The CPU 201 of the reproduction support apparatus 101 extracts the files identified from the extracted records from the database 111 and copies the extracted files to the position of the after-installation path in the storage apparatus 202 of the reproducing apparatus 103 (step S1502). For example, the CPU 201 extracts the file having a file name that includes the identifier that is recorded at the position of the after-installation path name of the record of the matching file list, in the database 111. For this copying, the reproduction support apparatus 101 converts the file name of the extracted file into the after-installation file name, executes the copying, and causes the reproduced OS for investigation production process to come to an end.

As described, in the embodiment, the reproduction support apparatus 101 can copy the files necessary for reproducing an OS that is the same as that of the customer apparatus 102, into the reproducing apparatus 103. Therefore, the reproducing apparatus 103 is able to easily construct the reproduced OS for investigation and execute reproduction investigation of the fault. The reproduction support apparatus 101 merely has to copy the constituent files of the OS from the database 111 to the reproducing apparatus 103 and does not need to execute application of any patch. Therefore, the labor and the time necessary for the application of the patches can be excluded.

The all-files information 113 transmitted by the customer apparatus 102 (or recorded on the recording medium) does not include the content itself of any file and therefore, any external leaks can be prevented of the content of any file that is the property of the customer and that is to be concealed. When the customer apparatus 102 produces the all-files information 113, the information concerning the files merely have to be collected and therefore, a situation is avoided such as the vendor imposing a tremendous load on the customer apparatus 102 by monopolizing and operating the customer apparatus 102 and copying all the files in the apparatus as has been conventionally executed. Therefore, suspension and delays of operations by the customer can be prevented.

The reproduction support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to the reproduction support apparatus, the reproduction support method, and the reproduction support program, an effect is achieved in that the time and labor necessary for reproducing the OS to be reproduced can be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A reproduction support apparatus that supports reproduction of an operating system (OS) that is to be reproduced by a reproducing apparatus different from an apparatus operated by the OS to be reproduced, the reproduction support apparatus comprising:
a processor configured to
input a first identification data group that includes identification data uniquely identifying files of a file group constituting the OS to be reproduced; and
a storage device that stores a second identification data group that includes identification data uniquely identifying files of a file group constituting OSs of an OS group including the OS to be reproduced and the files of the file group constituting the OSs of the OS group, wherein
that the processor is further configured to:
retrieve from the second identification data group in the storage device and for each identification data of the first identification data group, identification data matching identification data of the first identification data group;
extract from the file group stored in the storage device, a file identified by the retrieved identification data; and
transmit to the reproducing apparatus, information concerning files that are among the extracted files and that are for reproducing the OS to be reproduced by the reproducing apparatus.

2. The reproduction support apparatus according to claim 1, the processor further configured to
add identification data of files constituting an OS to the second identification data group, wherein
the processor inputs a file constituting an OS,
the processor retrieves from the second identification data group, identification data uniquely identifying the input file, and
when the identification data uniquely identifying the input file is not retrieved, the processor adds to the second identification data group, the identification data uniquely identifying the input file.

3. The reproduction support apparatus according to claim 1, wherein
the reproducing apparatus includes files of a file group constituting an OS at a time of first shipment of the OS to be reproduced, and
the processor transmits to the reproducing apparatus, files remaining after excluding from the file group including the extracted files, the files of the file group constituting the OS at the time of the first shipment of the OS to be reproduced.

4. The reproduction support apparatus according to claim 1, wherein
the processor inputs a file of a file group constituting an OS,
the processor retrieves from the second identification data group, identification data uniquely identifying the input file, and
the processor is further configured to
add the identification data uniquely identifying the input file to the second identification data group, when the identification data uniquely identifying the input file is not retrieved, and
the reproduction support apparatus further comprises
a storing unit that correlates and stores to the storage device that stores the file group constituting the OSs of the OS group, the input file and the identification data uniquely identifying the input file.

5. A reproduction support method executed by a reproduction support apparatus that supports reproduction of an operating system that is to be reproduced by a reproducing apparatus that is different from an apparatus operated by the OS to be reproduced, the reproduction support method comprising:
retrieving for each first identification data group that includes identification data uniquely identifying files of a file group constituting the OS to be reproduced, identification data that matches identification data of a first identification data group, from a storage device that stores a second identification data group that includes identification data uniquely identifying files of a file group constituting OSs of an OS group that includes the OS to be reproduced, the storage device further stores the files of the file group constituting the OSs of the OS group;
extracting from the file group stored in the storage device, a file identified by the retrieved identification data; and
transmitting to the reproducing apparatus, information concerning files that are the extracted files and that are for reproducing the OS to be reproduced by the reproducing apparatus.

6. The reproduction support method according to claim 5, wherein
the retrieving includes retrieving from the second identification data group, identification data uniquely identifying a file of the file group constituting an OS; and
the reproduction support method further comprises:
adding to the identification data group, the identification data uniquely identifying the file of the file group constituting the OS, when no identification data is retrieved; and
correlating and storing to the storage device, the file of the file group constituting the OS and the identification data uniquely identifying the file of the file group constituting the OS.

7. A computer-readable recording medium that stores a reproduction support program that causes a computer that supports reproduction of an operating system that is to be reproduced by a reproducing apparatus that is different from an apparatus operated by the OS to be reproduced, to execute a process comprising:
retrieving for each first identification data group that includes identification data uniquely identifying files of a file group constituting the OS to be reproduced, identification data that matches identification data of a first identification data group, from a storage device that stores a second identification data group that includes identification data uniquely identifying files of a file group constituting OSs of an OS group that includes the OS to be reproduced, the storage device further stores the files of the file group constituting the OSs of the OS group;
extracting from the file group stored in the storage device, a file identified by the retrieved identification data; and
transmitting to the reproducing apparatus, information concerning files that are the extracted files and that are for reproducing the OS to be reproduced by the reproducing apparatus.

8. The computer-readable recording medium according to claim 7, wherein
the retrieving includes retrieving from the second identification data group, identification data uniquely identifying a file of the file group constituting an OS; and
the process further comprises:
adding to the identification data group, the identification data uniquely identifying the file of the file group constituting the OS, when no identification data is retrieved; and
correlating and storing to the storage device, the file of the file group constituting the OS and the identification data uniquely identifying the file of the file group constituting the OS.
